(19) United States
(12) Patent Application Publication
(10) Pub. No.: US 2012/0237131 A1
(43) Pub. Date: Sep. 20, 2012

(54) INFORMATION PROCESSING APPARATUS TO ACQUIRE CHARACTER INFORMATION

(75) Inventors: Nobumitsu Ito, Kahoku-shi (JP); Takashi Sawada, Kahoku-shi (JP); Masahiro Fujitsuka, Kahoku-shi (JP); Tatsuya Mogi, Kahoku-shi (JP)

(73) Assignee: PFU LIMITED, Kahoku-shi (JP)

(21) Appl. No.: 13/410,930

(22) Filed: Mar. 2, 2012

(30) Foreign Application Priority Data
Mar. 17, 2011 (JP) 2011-059362

(51) Int. Cl. G06K 9/72

(52) U.S. Cl. 382/229

(57) ABSTRACT

An information processing apparatus according to one aspect of the present invention includes a area recognizing unit to recognize, with respect to areas specified in predetermined representations within image data, a first area specified in a first area specifying representation and a second area specified in a second area specifying representation different from the first area specifying representation, a position information acquiring unit to acquire position information of the first area, which is recognized by the area recognizing unit as the position information for specifying a character recognition target area within the image data and a name-of-item acquiring unit to acquire character information obtained by recognizing characters existing in the second area recognized by the area recognizing unit as a name of item with respect to the character recognition target area specified by the position information acquired by the position information acquiring unit.

### CROSS-REFERENCE TO RELATED APPLICATIONS

This application is based upon and claims the benefit of priority of the prior Japanese Patent Application No. JP2011-059362, filed on Mar. 17, 2011, the entire contents of which are incorporated herein by reference.

### FIELD

The present invention relates to technologies of an information processing apparatus, an information processing method and a program.

### BACKGROUND

Over the recent years, paperless operations have been accelerated for a variety of services and works in terms of improving the services and works and reducing costs. While on the other hand, there still exist a good number of scenes of utilizing the paper such as transaction documents. OCR (Optical Character Recognition) software has hitherto been employed for improving efficiency of the services and works using these sheets of paper.

The OCR software such as this entails definition information of reading areas etc in order to specify these reading areas etc.

For example, there is known a technology of reading a type of characters corresponding to a color by scanning image data on a color-by-color basis (Japanese Utility Model Application Laid-Open Publication No. H05-008670). Further, there is known another technology of generating an attribute information definition entity of read items by recognizing attribute information written into areas framed in predetermined colors (Japanese Patent Application Laid-Open Publication No. H05-081472).

In the conventional technologies, however, users are required to, on the occasion of generating the definition information for the OCR software, set names of items, through manual inputs, indicating contents written to the read areas with respect to the position information of the read areas acquired from the image data.

### SUMMARY

According to one aspect of the present invention, an information processing apparatus includes an area recognizing unit to recognize, with respect to areas specified in predetermined representations within image data, a first area specified in a first area specifying representation and a second area specified in a second area specifying representation different from the first area specifying representation, a position information acquiring unit to acquire position information of the first area, which is recognized by the area recognizing unit as the position information for specifying a character recognition target area within the image data and a name-of-item acquiring unit to acquire character information obtained by recognizing characters existing in the second area recognized by the area recognizing unit as a name of item with respect to the character recognition target area specified by the position information acquired by the position information acquiring unit.

It should be noted that the present invention, by way of other modes of one aspect of the present invention, may also be an information processing method for realizing the configurations described above, further be a program and still further be a non-transitory computer-readable medium which retains such a program. Herein, the non-transitory storage medium, which can be read by the computer etc, connotes a medium that retains information such as programs, etc. electrically, magnetically, optically, mechanically or by chemical action. Moreover, yet another mode of the present invention may also be an information processing system in which a plurality of apparatuses realizing the respective configurations described above is configured to enable the communications.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates processes of an information processing apparatus according to an embodiment.

FIG. 2 illustrates a configuration of the information processing apparatus according to the embodiment.

FIG. 3 is a flowchart depicting one example of a processing procedure of the information processing apparatus according to the embodiment.

FIG. 4 depicts one example of image data processed by the information processing apparatus according to the embodiment.

FIG. 5 depicts one example of a sequence of scanning a first area and a second area.

FIG. 6 depicts one example of how the first area and the second area are associated with each other.

FIG. 7 depicts another example of how the first area and the second area are associated with each other.

FIG. 8 depicts still another example of how the first area and the second area are associated with each other.

FIG. 9 depicts yet another example of how the first area and the second area are associated with each other.

FIG. 10 depicts one example of item definition information acquired from the image data illustrated in FIG. 4.

### DESCRIPTION OF EMBODIMENT

The following are discussions on embodiments (which will hereinafter be each referred to also as the present embodiment or simply the embodiment) of an information processing apparatus, an information processing method and a program according to one aspect of the present invention. The embodiments are, however, exemplifications, and the present invention is not limited to configurations of the embodiments.

It should be noted that data given in the embodiment are described in a natural language (English etc) and, more tangibly, specified in a pseudo language, commands, parameters, a machine language, etc, which are recognizable to a computer.

### §1 Information Processing Apparatus

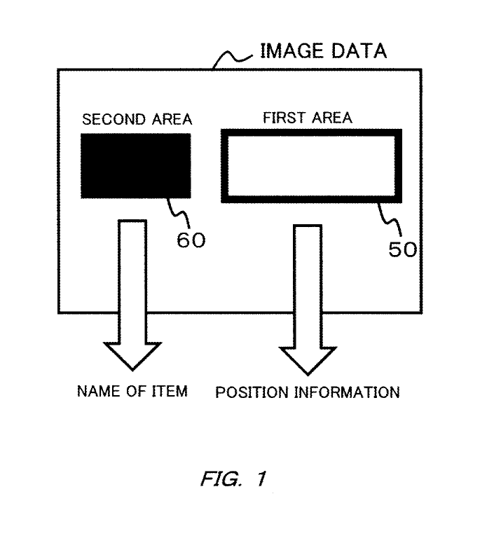

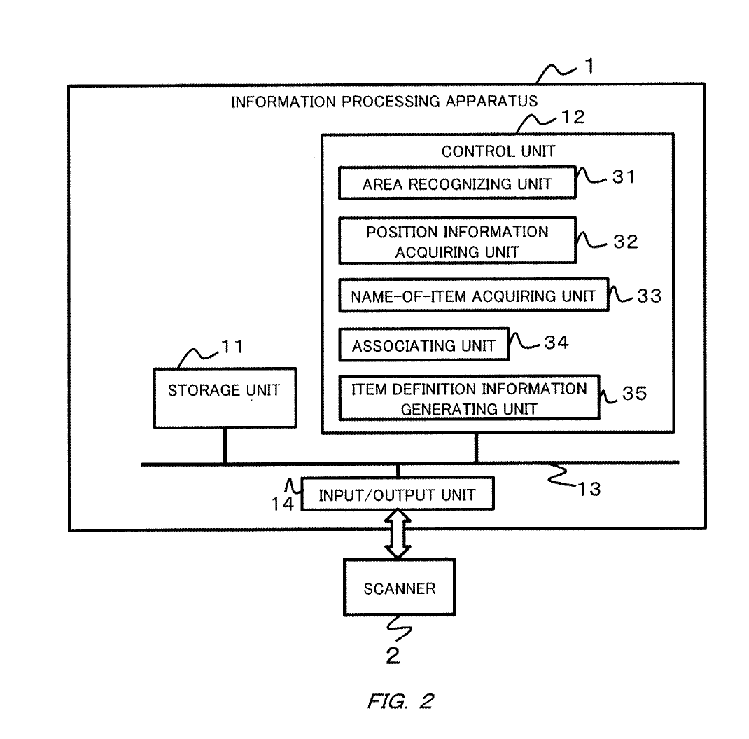

An information processing apparatus according to the embodiment will hereinafter be described with reference to FIGS. 1 and 2.

FIG. 1 illustrates a process that is executed by the information processing apparatus according to the embodiment. The information processing apparatus according to the embodiment recognizes a first area 50 and a second area 60, which are specified in predetermined representations within image data.

The first area 50 is specified in a first area specifying representation. On the other hand, the second area 60 is specified in the second area specifying representation. Namely, the first area 50 and the second area 60 are different in terms of their area specifying representations. The area specifying representation is defined as a representation for specifying the area and is exemplified such as a frame, filling and various types of hatchings. In an example illustrated in FIG. 1, the first area specifying representation is based on only the frame. To be specific, the first area specifying representation involves neither filling nor the various types of hatchings, etc, which are applied to within the frame. While on the other hand, the second area specifying representation is attained by filling in the example depicted in FIG. 1.

The first area 50 is an area specified as a character recognition target area within the image data. Further, the second area 60 is an area in which a name of item pertaining to the area that is specified as the character recognition target area.

For instance, a user draws the frame, does the filling or depicts the various types of hatchings by use of a marker and a seal or by printing etc on a sheet of paper such as a form or a clinical chart, thus specifying the first area and the second area 60. The information processing apparatus reads the paper on which the first area 50 and the second area 60 are thus specified through a scanner etc, thereby acquiring the image data containing the first area 50 and the second area 60 each specified therein.

The information processing apparatus according to the embodiment recognizes the first area 50 and the second area 60, which are specified in the different area specifying representations. Then, the information processing apparatus according to the embodiment acquires position information for specifying the character recognition target area from the first area 50. Further, the information processing apparatus according to the embodiment acquires the name of item pertaining to the character recognition target area from the second area 60.

Thus, the information processing apparatus according to the embodiment acquires the position information and the name of item respectively with respect to the character recognition target area from the first area and the second area that are specified on the image data, thereby enhancing the efficiency of user-based generation of the definition information.

It is to be noted that the user may specify the first area 50 and the second area 60 on the image data by editing the image data with the aid of rendering software etc.

FIG. 2 depicts an example of a configuration of an information processing apparatus 1 according to the embodiment. As depicted in FIG. 2, the information processing apparatus 1 includes, as hardware components, a storage unit 11, a control unit 12, an input/output (I/O) unit 14, etc, which are connected to a bus 13.

Various items of data and various categories of programs (unillustrated), which are employed in processes executed by the control unit 12, are stored in the storage unit 11. The storage unit 11 is realized by, e.g., a hard disk. The storage unit 11 may also be realized by a storage medium such as a USB (Universal Serial Bus) memory.

Note that the varieties of data and programs stored in the storage unit 11 may be acquired from the storage medium such as a CD (Compact Disc) or a DVD (Digital Versatile Disc). Further, the storage unit 11 may be called an auxiliary storage device.

The control unit 12 includes a single or a plurality of processors such as a microprocessor (s) or a CPU (s) (Central Processing Unit(s)) and peripheral circuits (ROM (Read Only Memory), RAM (Random Access Memory), interface circuit, etc) used in processes of the processor(s). The control unit 12 executes the varieties of data and programs stored in the storage unit 11, thereby realizing the processes of the information processing apparatus 1 in the embodiment. The ROM, the RAM, etc may be called main storage devices in the sense that these memories are located in address spaces handled by the processor within the control unit 12.

The I/O unit 14 is a single or a plurality of interfaces for transmitting and receiving the data to and from the device existing outside the information processing apparatus 1. The I/O unit 14 is defined as an interface for connecting, e.g., a LAN (Local Area Network) cable, an interface for connecting with a user interface (UI) of an input device and an output device etc or an interface of USB (Universal Serial Bus) etc.

The I/O unit 14 may be, as depicted in FIG. 2, connected to, e.g., a scanner 2. Further, the I/O unit 14 may be connected to an unillustrated user interface (an input/output device such as a touch panel, a ten key, a keyboard, a mouse and a display). Still further, the I/O unit 14 may be connected to a detachable recording medium input/output device such as a CD drive and a DVD drive or connected to an input/output device of a nonvolatile portable recording medium etc such as a memory card. The I/O unit 14 may have a function as an interface (a communication unit) which establishes a network connection.

The information processing apparatus according to the embodiment acquires the position information and the name of item respectively with respect to the character recognition target area, thereby enhancing the efficiency of user-based generation of the definition information. This process is realized as a process of the control unit 12.

As illustrated in FIG. 2, the control unit 12 includes, for realizing the processes described above, an area recognizing unit 31, a position information acquiring unit 32, a name-of-item acquiring unit 33, an associating unit 34 and an item definition information generating unit 35. The area recognizing unit 31, the position information acquiring unit 32, the name-of-item acquiring unit 33, the associating unit 34 and the item definition information generating unit 35, are realized in such a way that the programs etc stored in, e.g., the storage unit 11 are deployed on the RAMs serving as the peripheral circuits to the control unit 12 and then executed by the processor of the control unit 12.

The area recognizing unit 31 recognizes, with respect to the areas specified in the predetermined representations within the image data, the first area specified in the first area specifying representation and the second area specified in the second area specifying representation which is different from the first area specifying representation. The area recognizing unit 31 recognizes the first area 50 and the second area 60 in distinction therebetween, which are depicted in, e.g., FIG. 1.

The position information acquiring unit 32 acquires the position information of the first area recognized by the area recognizing unit, as the position information for specifying the character recognition target area within the image data. As depicted in FIG. 1, the position information acquiring unit 32 acquires the position information of the first area 50 within the image data, as the position information for specifying, e.g., the character recognition target area.

Note that the position information acquiring unit 32 may acquire the position information of the second area for the process of the associating unit 34 which will be described later on. The position information acquiring unit 32 may acquire the position information of the second area 60 within the image data depicted in, e.g., FIG. 1.

The name-of-item acquiring unit 33 acquires character information obtained by recognizing characters existing in the second area recognized by the area recognizing unit 31, as the name of item with respect to the character recognition target area specified by the position information acquired by the position information acquiring unit 32. As illustrated in FIG. 1, for instance, the name-of-item acquiring unit 33 acquires, as the name of item pertaining to the first area 50, the character information obtained by recognizing the characters existing within the second area.

Note that as will be described later on, the associating unit 34 associates the first area and the second area with each other. The name-of-item acquiring unit 33 according to the embodiment acquires the character information obtained from the second area by way of the name of item with respect to the character recognition target area specified by the position information obtained from the first area associated with the second area by the associating unit 34.

The associating unit 34 associates the first area with the second area. For example, the associating unit 34 associates the first area with the second area located closest to the first area in terms of the image data.

Further, for instance, the associating unit 34 determines whether a positional relation between the position of the first area and the position of the second area satisfies a predetermined condition or not, and associates the first area and the second area with each other, which have been determined to satisfy the predetermined condition. The “predetermined condition” conditionalizes the positional relation between the first area and the second area that are in the associative relation. Details thereof will be described later on.

Moreover, for example, the associating unit 34 recognizes an associative relation indicating expression which indicates how the first area and the second area each existing within the image data are associated with each other. Then, the associating unit 34 associates the first area and the second area with each other on the basis of the thus-recognized associative relation.

The associative relation indicating expression represents how the first area is associated with the second area. For example, the associative relation indicating expression is made by arrows provided between the first area and the second area, a line segment which connects the first area to the second area and the same symbols or marks drawn on the first area and the second area. Whatever expressions, if capable of expressing the associative relation between the first area and the second area, may be applied to the associative relation indicating expression.

The item definition information generating unit 35 generates apiece of item definition information containing the position information for specifying the character recognition target area, which is acquired by the position information acquiring unit 32 and containing the name of item pertaining to the character recognition target area specified by the position information, which is acquired by the name-of-item acquiring unit 33. The thus-generated item definition information is defined as information which specifies the name of item and the position of the character recognition target area. The item definition information is used by, e.g., OCR software etc.

### §2 Operational Example

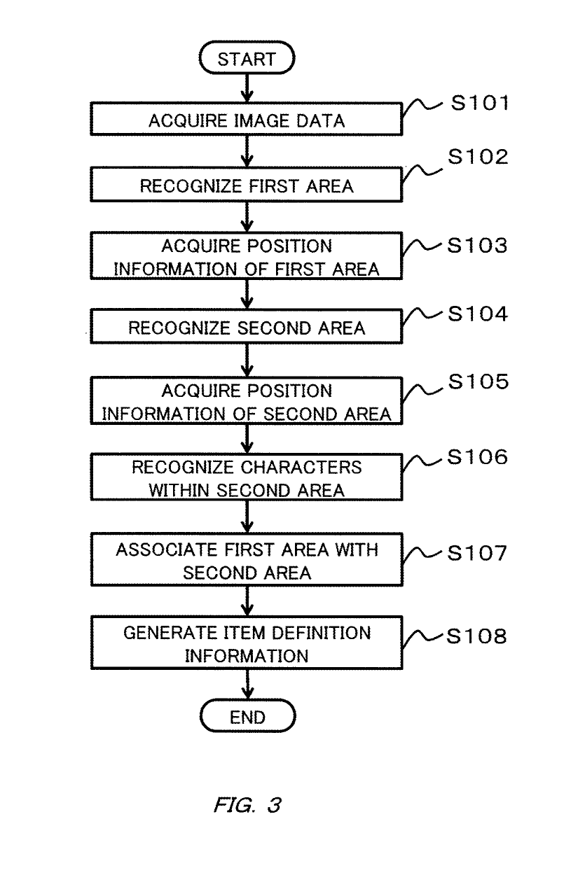

Next, an operational example of the information processing apparatus 1 according to the embodiment will be described with reference to FIG. 3. FIG. 3 depicts one example of a processing procedure of the information processing apparatus 1 according to the embodiment. Note that step is abbreviated to “S” in FIG. 3.

<Start>

To start with, for instance, the program stored in the storage unit 11 is deployed on the RAM etc of the control unit 12 in response to a user's operation. Then, the program deployed on the RAM etc of the control unit 12 is executed by the processor of the control unit 12. Thus, the information processing apparatus 1 starts processing.

<Step 101>

Next, the control unit 12 acquires the image data used in the process (S101). The image data to be acquired may be data captured by the scanner 2 illustrated in, e.g., FIG. 2. Further, the image data to be acquired may also be data stored in the storage unit 11. The image data such as this may be acquired via a network. Still further, the image data may also be acquired from a nonvolatile portable recording medium etc such as the memory card.

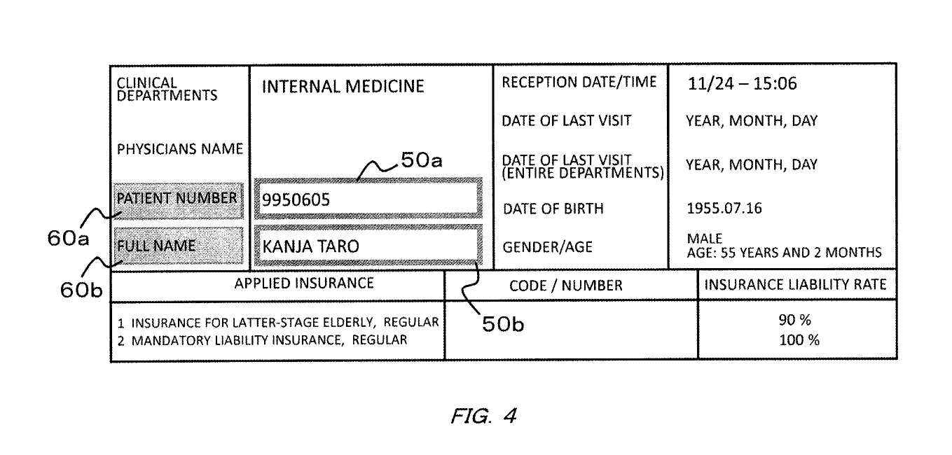

FIG. 4 depicts one example of the image data acquired at this time. The image data is the data obtained by digitizing the paper medium such as the form and the clinical chart. As illustrated in FIG. 4, the first areas (50a, 50b) and the second areas (60a, 60b) are specified on the columns and characters etc described in the form and the clinical chart etc. The first areas (50a, 50b) and the second areas (60a, 60b) are so expressed as to be distinguishable from the columns and the characters etc described in the form and the clinical chart etc.

For instance, the first areas (50a, 50b) and the second areas (60a, 60b) may be expressed in different colors from those of the columns and the characters etc described in the form and the clinical chart etc in order to clearly distinguish from the columns and the characters etc described in the form and the clinical chart etc. If expressed in this way, only the area specifying expressions related to the first areas (50a, 50b) and the second areas (60a, 60b) can be extracted from within those depicted within the image data by an OCR engine which reads the characters in a manner that detects the different colors. For example, if the columns and the characters etc described in the form and the clinical chart etc are assumed to be black, the OCR engine extracts the first areas (50a, 50b) and the second areas (60a, 60b) by reading the characters while detecting the colors other than black.

The first areas (50a, 50b) and the second areas (60a, 60b) do not, however, have to be expressed invariably in the different colors from those of the columns and the characters etc described in the form and the clinical chart etc. For instance, the first areas (50a, 50b) and the second areas (60a, 60b) may be, if expressed in the area specifying expressions distinguishable from the area specifying expressions of the columns etc described in the form and the clinical chart etc, expressed in the same colors as those of the columns and the characters etc described in the form and the clinical chart etc.

<Step 102>

Next, as depicted in FIG. 3, the control unit 12 recognizes the first area within the image data that is acquired in S101 (S102).

In the image data illustrated in FIG. 4, the frame is used as the first area specifying expression. In other words, in the image data depicted in FIG. 4, the first areas (50a, 50b) are expressed by the frames. The control unit 12 recognizes the first areas (50a, 50b) expressed by the frames.

For example, the control unit 12 extracts the area specifying expressions with respect to the first area and the second area from within those depicted within the image data. This extraction can be executed because of the first areas (50a, 50b) and the second areas (60a, 60b) being so expressed as to be distinguishable from the columns and the characters etc described in the form and the clinical chart etc. Subsequently, the control unit 12 specifies the area related to the first area specifying expression from the thus-extracted area specifying expressions pertaining to the first area and the second area. This specification is realized by, e.g., pattern matching etc. Then, the control unit 12 recognizes the specified area as the first area. Thus, the control unit 12 recognizes the first areas (50a, 50b) expressed by the frames within the image data depicted in FIG. 4.

<Step 103>

Next, the control unit 12 acquires the intra-image-data position information of the first area recognized in S102 (S103).

Any inconvenience may not be caused by using whatever information as the position information if being information indicating the position within the image data. In the embodiment, the position information is expressed in an x-y coordinate system, where the origin is set at the left upper edge of the image data, the axis of abscissas is set as the x-axis, and the axis of ordinates is set as the y-axis. The expression of the position information is not, however, limited to the x-y coordinate system. For instance, the expression of the position information may be attained by a polar coordinate system, where the origin is set at one unspecified point (e.g., the center of the image data) of the image data.

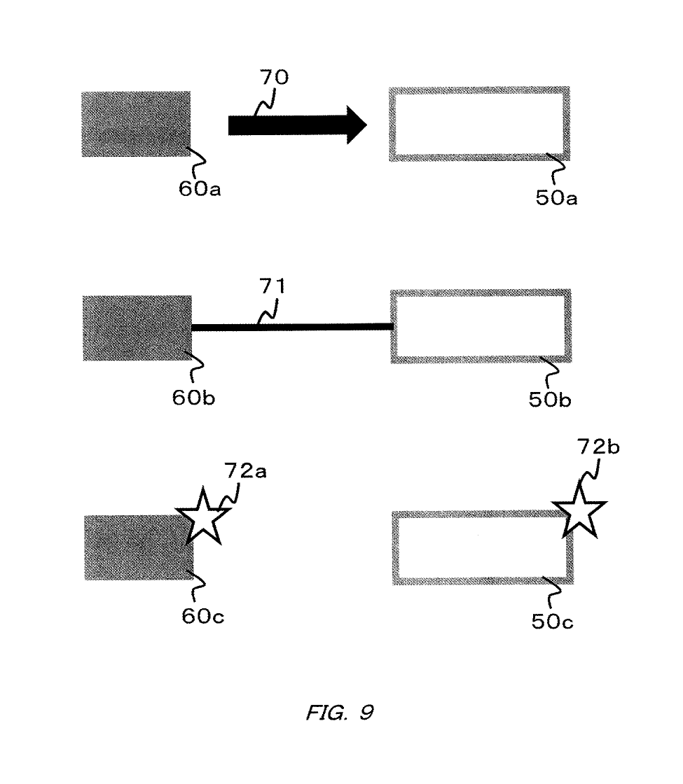

Further, the position information of the first area according to the embodiment contains a position (coordinate) of the left upper edge, a crosswise length and a longitudinal length of the first area. The position information is exemplified in FIG. 9 that will be illustrated afterwards. The control unit 12 specifies the position coordinate of the left upper edge of the first area recognized in S102. Further, the control unit 12 specifies the crosswise length and the longitudinal length of the thus-recognized first area. Through this operation, the control unit 12 acquires the intra-image-data position information of the recognized first area.

<Step 104>

Next, the control unit 12 recognizes the second area within the image data acquired in S101 (S104).

In the image data depicted in FIG. 4, the filling is employed by way of the second area specifying expression. In other words, in the image data illustrated in FIG. 4, the second areas (60a, 60b) are expressed by the filling. The control unit 12 recognizes the second areas (60a, 60b) expressed by the filling. Note that the recognition of the second area is done by the same method as the recognition method of the first area in S102.

<Step 105>

Subsequently, the control unit 12 acquires the intra-image-data position information of the second area recognized in S104 (S105). Incidentally, S105 may be omitted. In the embodiment, the associating process in S107, which will be described later on, involves using the position information of the second area, and hence the position information of the second area is acquired. Note that the position information of the second area is the same as the position information of the first area in S103.

<Step 106>

Next, the control unit 12 recognizes the characters existing in the second area recognized in S104, thus acquiring the character information of the characters existing within the second area (S106).

The character recognition may be executed by any method. In S106, the control unit 12 acquires the character information of the characters described within the second area by recognizing the characters described within the second area.

It should be noted that the character information is acquired as the name of item with respect to the first area serving as the character recognition target area. If the first area and the second area exist on a one-by-one basis, it is considered that the first area and the second area are combined one way, and hence there is no necessity for specifying the associative relation between the first area and the second area. Name it is unnecessary for specifying which first area the character information acquired from the second area in S106 represents the name of item about. At a point of time when acquiring the character information in S106, the character information is specified as the name of item about the first area in S102 and S103.

While on the other hand, if a plurality of first areas and a plurality of second areas exist respectively, there is the necessity for specifying which first area the character information acquired from the second area represent the name of item about. In the embodiment, S107 that will be explained afterwards, the first areas are associated with the second areas, thereby specifying which first area the character information acquired from the second area represents the name of item about.

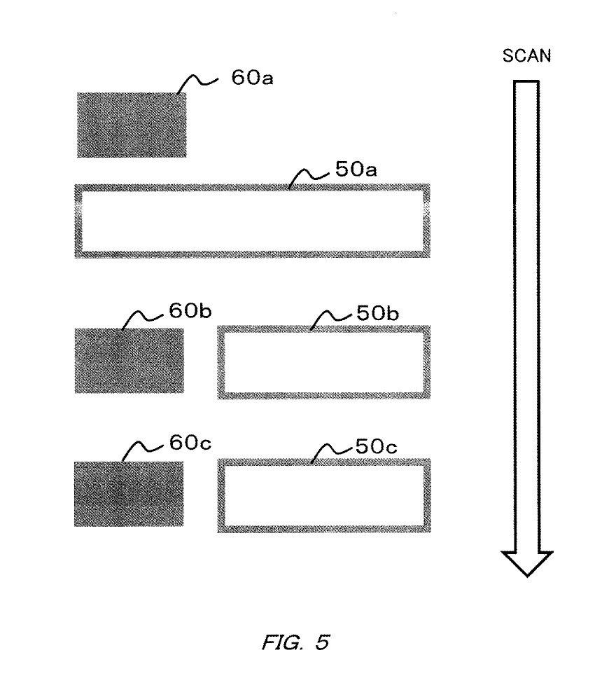

The associating process such as this does not, however, have to be required invariably. For instance, as depicted in FIG. 5, an assumption is that the control unit 12 sequentially scans the image data from the upper portion thereof and executes the recognition of the first area in S102 and the recognition of the second area in S104. Then, it is also assumed that the control unit 12 repeats the processes in S102-S106 each time the control unit 12 detects one first area and one second area. At this time, the first area and the second area related to the processing are each invariably the single area, and therefore the associating process is not required.

Note that, e.g., the processing being thus executed, in the example depicted in FIG. 5, the character information acquired from the second area 60a is specified as the name of item with respect to the first area 50a. Further, the character information acquired from the second area 60b is specified as the name of item related to the first area 50b. The character information acquired from the second area 60c is specified as the name of item related to the first area 50c. Note that in these processes, steps S102-S103 could be replaced by steps S104-S106 depending on a detection order of the first area and the second area.

<Step 107>

Subsequently, the control unit 12 associates the first areas and the second areas with each other in order to specify the associative relation between the first areas recognized in S102 and the second areas recognized in S104. This step 107 may be omitted if the first area and the second area related to the associating process exist on the one-by-one basis. The step 107 is, as described above, a process for specifying which first area the character information acquired from the second area represents the name of item about.

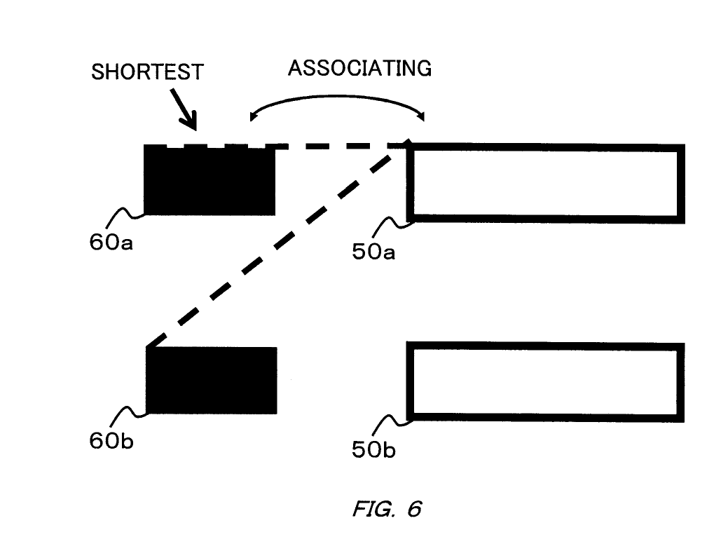

An example of the processing related to the associating process by the control unit 12 will be explained with reference to FIGS. 6-9.

For example, the control unit 12 associates the first area with the second area located nearest to this first area on the image data. FIG. 6 depicts an example of this process. In the embodiment, the position information of the first and second areas is acquired in S103 and S105. The position information contains the coordinate of the position of the left upper edge of each area. The control unit 12 calculates each distance between the first area and the second area by use of the position coordinate. To be specific, the control unit 12 calculates a distance between the position coordinate of the left upper edge of each of the first areas and the position coordinate of the left upper edge of each of the second areas. Then, the control unit 12 associates the first area and the second area with each other, between which the distance is shortest.

An example depicted in FIG. 6 is that the control unit 12 associates the first area 50a with the second area 60a nearest to this first area 50a on the image data. Further, the first area 50b is associated with the second area 60b existing closest to this first area 50b.

Note that the first area and the second area in the process concerned may be replaced with each other. Namely, the control unit 12 may associate the second area with the first area existing closest to this second area on the image data.

Further, the control unit 12 determines whether the positional relation between the position of the first area and the position of the second area satisfies a predetermined condition or not, and may associate the first area and the second area with each other, between which the positional relation is determined to satisfy the predetermined condition.

The predetermined condition conditionalizes the positional relation between the first area and the second area that are in the associative relation.

For instance, the predetermined condition is related to the distance between the first area and the second area that take the associative relation. The control unit 12 determines that the predetermined condition is satisfied by the first area and the second area between which the distance is equal to or smaller than a threshold value enabled to be set and changed by the user in the first areas and the second areas existing within the image data.

Moreover, for example, the predetermined condition is related to a relative positional relation between the first area and the second area, which have the associative relation. The control unit 12 determines that the predetermined condition is satisfied by the first area and the second area, which are in a given relative positional relation, in the first areas and the second areas existing within the image data. Herein, in the embodiment, the relative positional relation can be expressed as a differential vector between a vector indicating the left upper edge of the first area and a vector indicating the left upper edge of the second area, in which the origin is set at the left upper edge of the image data. Further, the given relative positional relation can be expressed as a conditional vector that should be satisfied by the differential vector. Then, e.g., if a scalar product of the differential vector and the conditional vector is included in a range of values enabled to be set and changed by the user, the first area and the second area related to the differential vector are determined to be in the given relative positional relation.

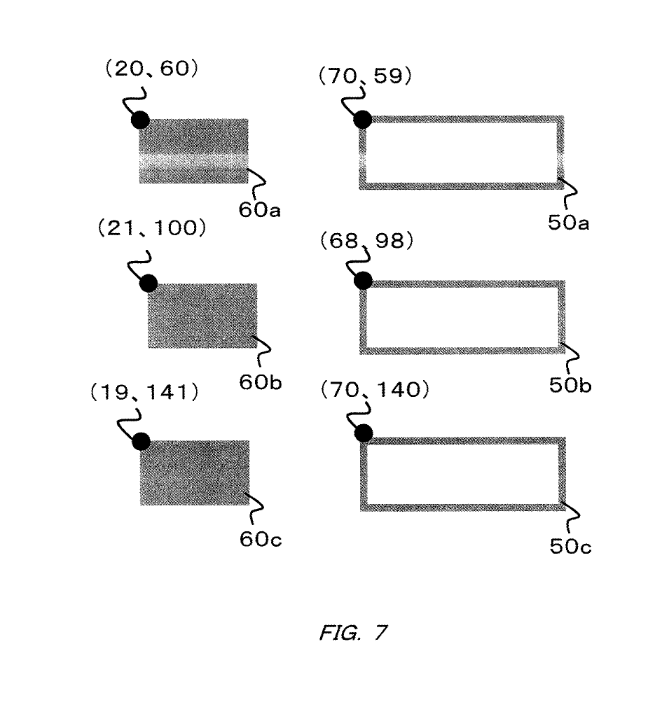

Furthermore, e.g., the predetermined condition pertains to the way of how the first area and the second area, which take the associative relation, are arranged in a crosswise direction. The control unit 12 determines that the predetermined condition is satisfied by the first area and the second area, which are arranged in the crosswise direction, among the first areas arranged in the longitudinal directions and the second areas arranged in the longitudinal direction within the image data. FIG. 7 exemplifies the first area and the second area that satisfy the predetermined condition. Note that x in the coordinates (x, y) represents the coordinate along the axis of abscissas (x-axis). Further, y represents the coordinate along the axis of ordinates (y-axis).

Herein, in the embodiment, the first area arranged in the longitudinal direction connotes the first area of which the position coordinate (x-coordinate), along the axis of abscissas (x-axis), of the left upper edge of the first area exists in the range of an error within a threshold value that can be set and changed by the user. For example, the x-coordinate of the first area 50a depicted in FIG. 7 is “70”. The x-coordinate of the first area 50b is “68”. The x-coordinate of the first area 50c is “70”. Supposing at this time that the threshold value is, e.g., “5”, the first area 50a, the first area 50b and the first area 50c are the first areas each arranged in the longitudinal direction.

This is applied to the second areas in the same way. In the embodiment, the second area arranged in the longitudinal direction connotes the second area of which the position coordinate (x-coordinate), along the axis of abscissas (x-axis), of the left upper edge of the second area exists in the range of the error within the threshold value that can be set and changed by the user. For instance, the x-coordinate of the second area 60a depicted in FIG. 7 is “20”. The x-coordinate of the second area 60b is “21”. The x-coordinate of the second area 60c is “19”. Supposing at this time that the threshold value is, e.g., “5”, the second area 60a, the second area 60b and the second area 60c are the second areas each arranged in the longitudinal direction.

The control unit 12 thus acquires the first areas arranged in the longitudinal direction and the second areas arranged in the longitudinal direction. Then, the control unit 12 determines that the predetermined condition is satisfied by the first area and the second area, which are arranged in the crosswise direction, among the first areas and the second areas arranged in the longitudinal direction.

Herein, in the embodiment, the first area and the second area are arranged in the crosswise direction, which implies that a difference between the position coordinate (y-coordinate), along the axis of ordinates (y-axis), of the left upper edge of the first area and the position coordinate, along the axis of ordinates, of the left upper edge of the second area is within the threshold value that can be set and changed by the user.

For instance, the y-coordinate of the first area 50a depicted in FIG. 7 is “59”. The y-coordinate of the first area 50b is “98”. The y-coordinate of the first area 50c is “140”. By contrast, the y-coordinate of the second area 60a illustrated in FIG. 7 is “60”. The y-coordinate of the second area 60b is “100”. The y-coordinate of the second area 60c is “141”.

Supposing at this time that the threshold value is, e.g., “5”, the control unit 12, the first area 50a and the second area 60a being arranged in the crosswise direction, determines that the predetermined condition is satisfied. Further, the control unit 12, the first area 50b and the second area 60b being arranged in the crosswise direction, determines that the predetermined condition is satisfied. Still further, the control unit 12, the first area 50c and the second area 60c being arranged in the crosswise direction, determines that the predetermined condition is satisfied. Namely, the control unit 12 associates the first area 50a with the second area 60a. Moreover, the control unit 12 associates the first area 50b with the second area 60b. Furthermore, the control unit 12 associates the first area 50c with the second area 60c.

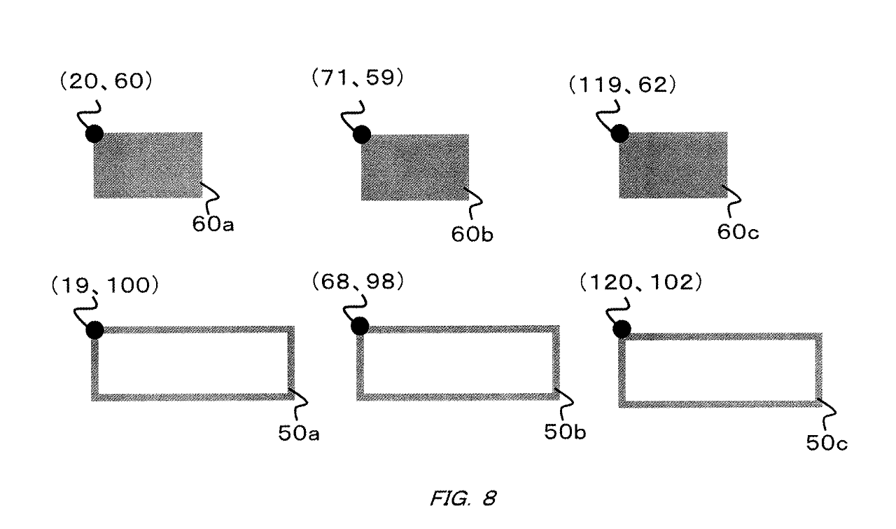

Further, for instance, the predetermined condition pertains to the way of how the first area and the second area, which are in the associative relation, are arranged in the longitudinal direction. The control unit 12 determines that the predetermined condition is satisfied by the first area and the second area, which are arranged in the longitudinal direction, among the first areas and the second areas arranged in the crosswise direction within the image data. FIG. 8 exemplifies the first area and the second area that satisfy the predetermined condition. The coordinates (x, y) in FIG. 8 are expressed in a manner similar to the coordinates in FIG. 7.

Herein, the determination as to whether the first area is arranged in the crosswise direction or not and the determination as to whether the second area is arranged in the crosswise direction or not are made in the same way as making the determination about whether the first area and the second area are arranged in the crosswise direction or not. Further, the determination as to whether the first area and the second area are arranged in the longitudinal direction or not is made in the same way as making the determination about whether the first area is arranged in the longitudinal direction or not and the determination about whether the second area is arranged in the longitudinal direction or not.

Supposing that the threshold value is, e.g., “5”, the control unit 12, the first area 50a and the second area 60a being arranged in the longitudinal direction in FIG. 8, determines that the predetermined condition is satisfied. Further, the control unit 12, the first area 50b and the second area 60b being arranged in the longitudinal direction, determines that the predetermined condition is satisfied. Still further, the control unit 12, the first area 50c and the second area 60c being arranged in the longitudinal direction, determines that the predetermined condition is satisfied. Namely, the control unit 12 associates the first area 50a with the second area 60a. Moreover, the control unit 12 associates the first area 50b with the second area 60b. Furthermore, the control unit 12 associates the first area 50c with the second area 60c.

Further, for example, the control unit 12 recognizes a predetermined associative relation specifying representation that represents the associative relation between the first area and the second area existing within the image data. Then, the control unit 12 associates, based on the associative relation specified by the thus-recognized associative relation specifying representation, the first area and the second area with each other.

The associative relation specifying representation specifies how the first area is associated with the second area. FIG. 9 exemplifies the associative relation specifying representation.

For example, the associative relation specifying representation is given by an arrow 70 illustrated in FIG. 9. For instance, the control unit 12 recognizes the arrow 70 existing within the image data. Then, the control unit 12 acquires vector information about the direction indicated by the arrow 70 from the recognized arrow 70. Further, the control unit 12 specifies the first area 50a and the second area 60a that are indicated by the arrow 70 by use of the acquired vector information. As a result, the control unit 12 associates the thus-specified first area 50a and second area 60a with each other.

Moreover, e.g., the associative relation specifying representation is given by a line segment 71 depicted in FIG. 9. For instance, the control unit 12 recognizes the line segment 71 existing within the image data. Then, the control unit 12 specifies the first area 50b and the second area 60b, which are connected by the line segment 71. As a consequence, the control unit 12 associates the specified first area 50b and second area 60b with each other.

Furthermore, e.g., the associative relation specifying representation is given by a symbol 72a and a symbol 72b illustrated in FIG. 9. For example, the control unit 12 recognizes the symbol 72a and the symbol 72b, which are identical with each other, existing within the image data. Then, the control unit 12 specifies the first area 50c and the second area 60c marked with the symbol 72a and the symbol 72b, which are identical with each other. As a result, the control unit 12 associates the thus-specified first area 50c and second area 60c with each other.

The control unit 12 associates, based on the associating methods exemplified so far, the first areas recognized in S102 with the second areas recognized in S104. It is to be noted that the control unit 12 may associate the first areas with the second areas by making a plurality of combinations of the associating methods exemplified so far.

<Step 108>

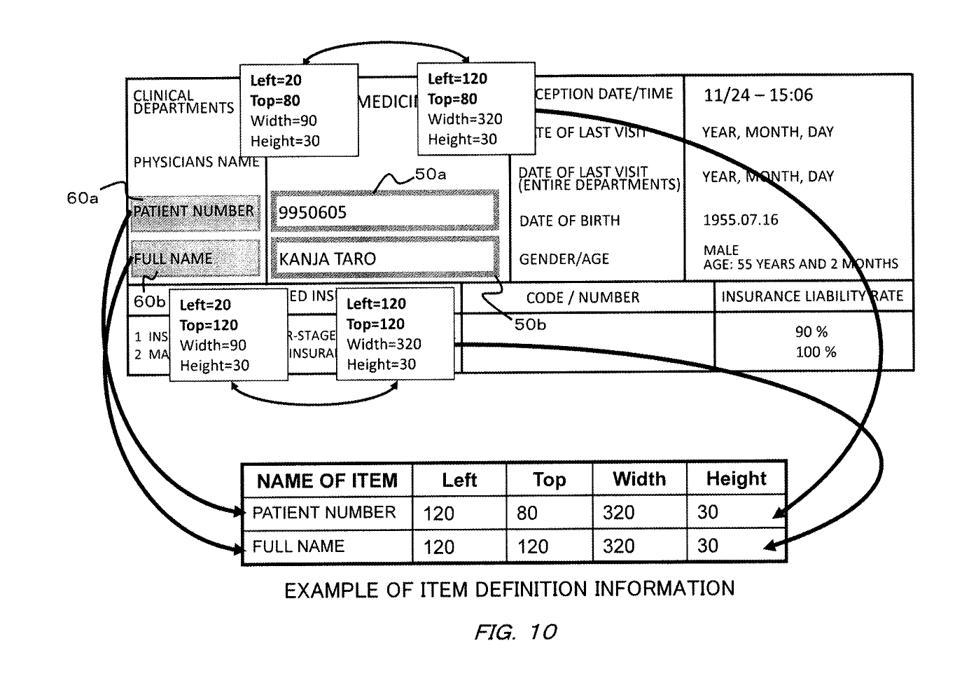

Subsequently, the control unit 12 generates item definition information containing the position information obtained in S103 and the name of item obtained in S106. FIG. 10 exemplifies the item definition information generated in S108 as a result of executing the processes in S102-S107 with respect to the image data depicted in FIG. 4.

As depicted in FIG. 10, the first area 50a is associated with the second area 60a. Further, the first area 50b is associated with the second area 60b.

Then, an x-coordinate (Left), a y-coordinate (Top), a horizontal length (Width) of the axis of abscissas and a vertical length (Height) of the axis of ordinates of the first area 50a are given by “120”, “80”, “320” and “30”, respectively. The x-coordinate, the y-coordinate, the horizontal length of the axis of abscissas and the vertical length of the axis of ordinates of the first area 50b are given by “120”, “120”, “320” and “30”, respectively. Moreover, the x-coordinate, the y-coordinate, the horizontal length of the axis of abscissas and the vertical length of the axis of ordinates of the second area 60a are given by “20”, “80”, “90” and “30”, respectively. The x-coordinate and the y-coordinate, the horizontal length of the axis of abscissas and the vertical length of the axis of ordinates of the second area 60b are given by “20”, “120”, “90” and “30”, respectively.

FIG. 10 exemplifies pieces of item definition information acquired from a set of the first area 50a and the second area 60a and a set of the first area 50b and the second area 60b such as this. Note that the character information obtained from the second area is stored in a “name of item” field in the item definition information exemplified in FIG. 10. The x-coordinate of the left upper edge of the first area is stored in a “Left” field. The y-coordinate of the left upper edge of the first area is stored in a “Top” field. The horizontal length of the axis of abscissas of the first area is stored in a “Width” field. The vertical length of the axis of ordinates of the first area is stored in a “Height” field.

Herein, row data (record) of the item definition information represents the information concerning the first area and the second area, which are in the associative relation. Namely, the record of the item definition information contains the position information and the name of item of the character recognition target area.

It should be noted that the OCR software etc may obtain the position information and the name of item of the character recognition target area from the record in the item definition information. In other words, the item definition information may be used for specifying the information on the character recognition target area via the OCR software etc.

Further, the control unit 12 may display, on a display device connected to the information processing apparatus 1, the position information and the name of item of the character recognition target area, which are obtained from the record in the item definition information, together with the image data in which these pieces of information exist.

<End>

Finally, the control unit 12 stores, e.g., the item definition information generated in S108 in the storage unit 11. Then, the information processing apparatus 1 terminates the processes related to the present operational example.

<Others>

It should be noted that the processes related to recognizing the first area and the second area by the control unit 12 in S102 and S104 correspond to the processes of the area recognizing unit 31.

The process related to acquiring the position information by the control unit 12 in S103 corresponds to the process of the position information acquiring unit 32.

The process related to acquiring the name of item by the control unit 12 in S106 corresponds to the process of the name-of-item acquiring unit 33.

The process related to the associating process by the control unit 12 in S106 corresponds to the process of the associating unit 34.

The process related to generating the item definition information by the control unit 12 in S108 corresponds to the process of the item definition information generating unit 35.

### §3 Operation and Effect according to Embodiment

According to what has been discussed so far, in the information processing apparatus 1 of the embodiment, the first area and the second area within the image data are recognized (S102 and S104). Then, the position information for specifying the character recognition target area is acquired from the first area (S103). Further, the name of item of the character recognition target area is obtained from the second area (S106).

Therefore, according to the information processing apparatus 1 of the embodiment, the user has no necessity for setting, through a manual input, the name of item of the character recognition target area related to the acquired position information. Hence, according to the information processing apparatus 1 of the embodiment, it is feasible to enhance the efficiency of generating the definition information used by the OCR software etc.

Moreover, in the information processing apparatus 1 according to the embodiment, the position information for specifying the character recognition target area is associated with the name of item of the character recognition target area (S107). Therefore, the user comes to have no necessity for associating the acquired position information with the name of item. Accordingly, the information processing apparatus 1 according to the embodiment enables the enhancement of the efficiency of generating the definition information used by the OCR software etc.

### §4 Supplement

The in-depth description of the embodiment of the present invention has been made above, however, the description given so far is no more than the exemplification of the present invention in whatever aspects but does not restrict the scope of the present invention. A variety of improvements and modifications can be, as a matter of course, made without deviating from the scope of the present invention.

It is feasible for those skilled in the art to implement the equivalent range from the description of the embodiment on the basis of the descriptions of Claims and the technical general knowledge. Further, the terminology used in the present specification is, unless specified otherwise, employed in a sense that is normally construed in the field concerned. Accordingly, unless defined otherwise, all of specialist terms and technical terms used in the present specification have the same meanings as the meanings that are generally understood by those skilled in the art of the field belonging to the present invention. If discrepant therebetween, the terminology used in the present specification shall be understood as the meanings (inclusive of the definitions) described in the present specification.

The present embodiment aims at providing the technology capable of enhancing the efficiency of generating the definition information used in the OCR software etc. Then, according to the present embodiment, it is possible to provide the technology capable of enhancing the efficiency of generating the definition information used in the OCR software etc.

1. An information processing apparatus, comprising:
an area recognizing unit to recognize, with respect to areas specified in predetermined representations within image data, a first area specified in a first area specifying representation and a second area specified in a second area specifying representation different from the first area specifying representation;
a position information acquiring unit to acquire position information of the first area, which is recognized by the area recognizing unit as the position information for specifying a character recognition target area within the image data; and
a name-of-item acquiring unit to acquire character information obtained by recognizing characters existing in the second area recognized by the area recognizing unit as a name of item with respect to the character recognition target area specified by the position information acquired by the position information acquiring unit.

2. The information processing apparatus according to claim 1, further comprising an associating unit to associate the first area and the second area with each other,
wherein the name-of-item acquiring unit acquires the character information obtained from the second area as a name of item with respect to the character recognition target area specified by the position information acquired from the first area associated with the second area by the associating unit.

3. The information processing apparatus according to claim 2, wherein the associating unit associates the first area with the second area located closest to the first area on the image data.

4. The information processing apparatus according to claim 2, wherein the associating unit determines whether a positional relation between a position of the first area and a position of the second area satisfies a predetermined condition or not, and associates the first area and the second area with each other, which are determined to satisfy the predetermined condition.

5. The information processing apparatus according to claim 4, wherein the associating unit determines that the predetermined condition is satisfied by the single first area and the single second area, which are arranged in a crosswise direction, in a plurality of first areas arranged in a longitudinal direction and a plurality of second areas arranged in the longitudinal direction within the image data.

6. The information processing apparatus according to claim 4, wherein the associating unit determines that the predetermined condition is satisfied by the single first area and the single second area, which are arranged in the longitudinal direction, in the plurality of first areas arranged in the crosswise direction and the plurality of second areas arranged in the crosswise direction within the image data.

7. The information processing apparatus according to claim 2, wherein the associating unit recognizes a predetermined associative relation specifying representation which represents an associative relation between the first area and the second area existing within the image data, and associates, based on the recognized associative relation, the first area and the second area with each other.

8. The information processing apparatus according to claim 1, further comprising an item definition information generating unit to generate item definition information containing the position information for specifying the character recognition target area, which is acquired by the position information acquiring unit, and the name of item with respect to the character recognition target area specified by the position information, which is acquired by the name-of-item acquiring unit.

9. An information processing method by which a computer executes:
recognizing, with respect to areas specified in predetermined representations within image data, a first area specified in a first area specifying representation and a second area specified in a second area specifying representation different from the first area specifying representation;
acquiring position information of the recognized first area as the position information for specifying a character recognition target area within the image data; and
acquiring character information obtained by recognizing characters existing in the recognized second area as a name of item with respect to the character recognition target area specified by the acquired position information.

10. A non-transitory computer-readable medium retaining a program to make a computer execute:
recognizing, with respect to areas specified in predetermined representations within image data, a first area specified in a first area specifying representation and a second area specified in a second area specifying representation different from the first area specifying representation;
acquiring position information of the recognized first area as the position information for specifying a character recognition target area within the image data; and
acquiring character information obtained by recognizing characters existing in the recognized second area as a name of item with respect to the character recognition target area specified by the acquired position information.
